(19) United States
(12) Patent Application Publication
(10) Pub. No.: US 2011/0198866 A1
(43) Pub. Date: Aug. 18, 2011

(54) SECURITY BOLT

(76) Inventors: John Benson, Sterling, IL (US); Randy Boonstra, Fulton, IL (US)

(21) Appl. No.: 12/707,336

(22) Filed: Feb. 17, 2010

(51) Int. Cl. E05C 1/04

(52) U.S. Cl. 292/150

(57) ABSTRACT

A security bolt includes a unitary case having a front surface, a rear surface and being formed to define a substantially enclosed, elongate passageway. A strike has a front surface, a rear surface and is formed to define a strike passageway being alignable with the elongate passageway. An elongate bolt is reciprocally engaged in the elongate passageway between a retracted position and an extended position in which a free end of the bolt is received in the strike passageway. At least one of the case and the strike is configured so that opposed edges engage each other at the rear surface along a line obscured by the respective front surface.

### BACKGROUND

The present invention relates to reciprocating bolt-type fasteners for securing doors, gates, windows and the like in a closed position, and more specifically to such fasteners which are lockable in position to prevent unwanted access from the side of the enclosure where the bolt fastener is located.

Bolt lock fasteners are well known in the art, exemplified by U.S. Pat. No. 48,555 to Hart, disclosing a plate forming a barrel through which a bolt reciprocates, and a corresponding strike receiving a free end of the bolt in the extended or locked position. The barrel is typically mounted to the moving door or window, and the strike is fixed to the surrounding jamb or frame. Both the plate and the strike have peripheral flanges used to secure the plate to the door or jamb, respectively. Also, the barrel includes transverse, usually vertical, slots for accommodating the bolt handle in either designated extended (locked) or retracted (released) positions. A main drawback of this type of lock is that when used in applications where the bolt is outside the enclosure being protected, such as a shed or cabinet, the locking effect can be readily neutralized by removing the exposed fasteners on the barrel flange. Another disadvantage of this arrangement is the inability to accommodate a padlock for restricting access to the enclosure being locked.

Some of the drawbacks of the traditional bolt design of Hart are addressed in U.S. Pat. No. 1,368,711 to Foley, disclosing a sliding bolt and strike where the fasteners securing the barrel are hidden behind the reciprocating bolt. The bolt is provided with apertures for accommodating a padlock. However, by modifying the barrel to provide access to the padlock apertures, the holding straps of the barrel are inherently weak and prone to bending or breakage by a pry bar for removing the bolt to gain access to the enclosure. Also, the bolt is constructed of shaped sheet material, which is inherently weaker than a solid rod-style bolt, as disclosed in Hart.

Thus, there is a need for providing an improved security bolt that addresses the drawbacks identified above, while being capable of competitively manufactured to conventional designs.

### SUMMARY

The above-identified need is met by the present security bolt, which provides a unitary case or barrel with hidden flanges located behind the bolt, and secured by fasteners which are hidden from view by an exterior cover of the case and the rod-like bolt. The case is configured for substantially enclosing the bolt in both the locked and unlocked positions. Apertures are provided in the case and matching strike for accommodating a padlock in either a locked or unlocked, storage position. Also, unitary support tabs are provided to both the case and the strike for fastening the components to the edge of the door or jamb. In addition, adjacent edges of the case and strike forming the enclosure are configured in an intermeshing relationship, with opposing intermeshed tabs each secured in place by fasteners for a more secure arrangement.

More specifically, a security bolt is provided, including a unitary case having a front surface, a rear surface and being formed to define a substantially enclosed, elongate passageway. A strike has a front surface, a rear surface and is formed to define a strike passageway being alignable with the elongate passageway. An elongate bolt is reciprocally engaged in the elongate passageway between a retracted position and an extended position in which a free end of the bolt is received in the strike passageway. At least one of the case and the strike is configured so that opposed edges engage each other at the rear surface along a line obscured by the respective front surface.

In another embodiment, a security bolt includes a unitary case having a front surface, a rear surface and being formed to define a substantially enclosed, elongate passageway. A strike has a front surface, a rear surface and is formed to define a strike passageway being alignable with the elongate passageway. An elongate bolt is reciprocally engaged in the elongate passageway between a retracted position and an extended position in which a free end of the bolt is received in the strike passageway. Both the case and the strike are configured so that opposed edges engage each other at the rear surface along a line obscured by the respective front surface. The rear surfaces are provided with interengaging tabs forming a notched, intermeshing relationship along the opposed edges of the formed case.

In still another embodiment, a security bolt includes a unitary case having a front surface, a rear surface and being formed to define a substantially enclosed, elongate passageway. A strike has a front surface, a rear surface and is formed to define a strike passageway being alignable with the elongate passageway. An elongate bolt is reciprocally engaged in the elongate passageway between a retracted position and an extended position in which a free end of the bolt is received in the strike passageway. Both the case and the strike are configured so that opposed edges engage each other at the rear surface along a line obscured by the respective front surface. The front surface of the case is broken only by a pair of padlock apertures, and a pair of connected, transverse bolt slots, the front surface of the strike is broken only by a pair of storage padlock apertures.

### BRIEF DESCRIPTION OF THE DRAWINGS

FIG. 1 is a top front perspective view of the present security bolt shown mounted to a door and provided with a padlock;

FIG. 2 is a top front exploded perspective view of the present security bolt;

FIG. 3 is a bottom assembled perspective view of the present security bolt;

FIG. 4 is an end elevational view of the present security bolt; and

FIG. 5 is a front elevational view of the security bolt of FIG. 3.

### DETAILED DESCRIPTION

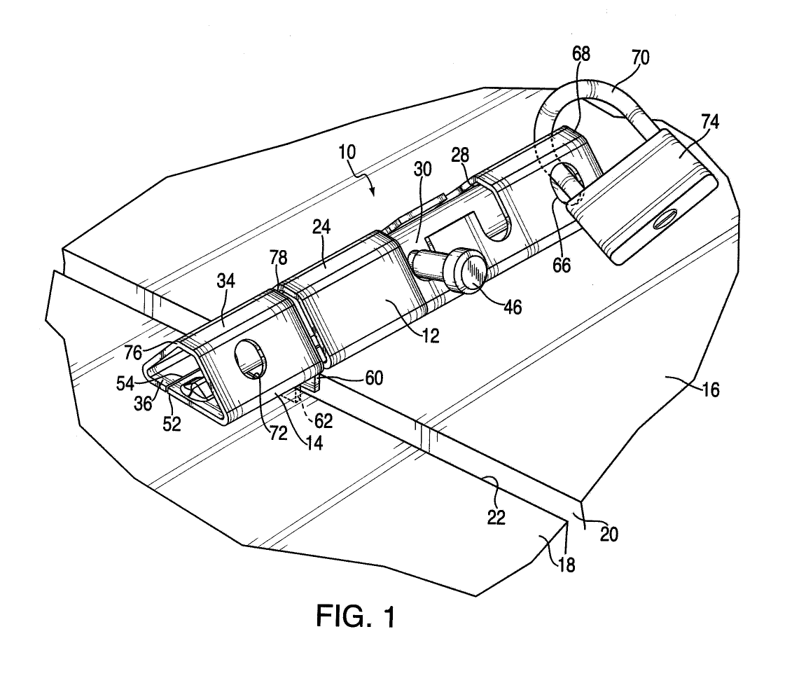

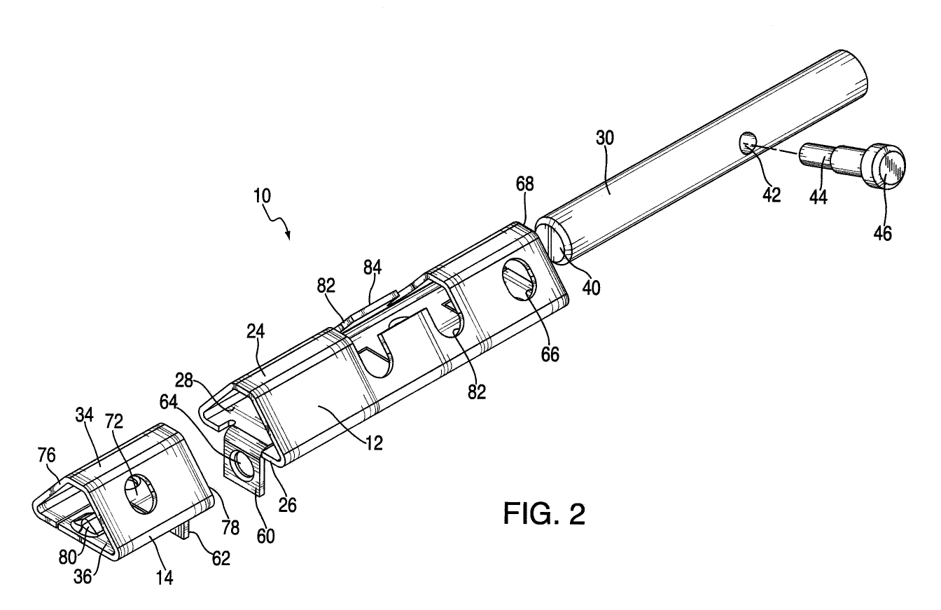

Referring to FIGS. 1 and 2, a security bolt is generally designated 10, and includes a case 12 and a strike 14, each aligned relative to the other and each respectively secured to a movable door, gate or window 16, and a fixed frame or jamb 18. It is contemplated that the case 12 and the strike 14 may be reversed in the mounting orientation from that depicted here. Each of the door 16 and the jamb 18 have a corresponding, opposed edge, 20, 22 (FIG. 5). When the door 16 is closed, the door and the jamb 18 are co-planar.

The case 12 is unitary, in that it is formed from a single piece of sheet material, preferably sturdy sheet metal or steel which may be hardened as desired. Upon being formed as desired the case 12 includes a front surface 24 and an opposite rear surface 26, the case forming a substantially enclosed, elongate passageway 28 configured for accommodating a linearly reciprocating bolt 30.

Referring now to FIGS. 1-5, the strike 14 is formed similarly to the case 12, and is made of a single piece of sheet material, having a front surface 34, a rear surface 36 and formed to define a strike passageway 38. The strike passageway 38 is alignable with the elongate enclosed passageway 28 when the strike 14 and the case 12 are mounted respectively to one of the door 16 and the jamb 18.

The bolt 30 reciprocates in the enclosed passageway 28 between a retracted position in which the door 16 may be opened, and an extended position (FIG. 1) in which a free end 40 of the bolt is received in the strike passageway 38, thus locking the door. As is well known in the art, the bolt 30 is preferably a solid rod of steel, preferably hardened; having a transverse bore 42 (FIG. 2) configured for accommodating a stem 44 of a handle 46 projecting generally transverse to a longitudinal axis of the bolt. In the preferred embodiment, the stem 44 is force or friction fit and/or welded in place in the bore 42; however other conventional fastening technologies are contemplated.

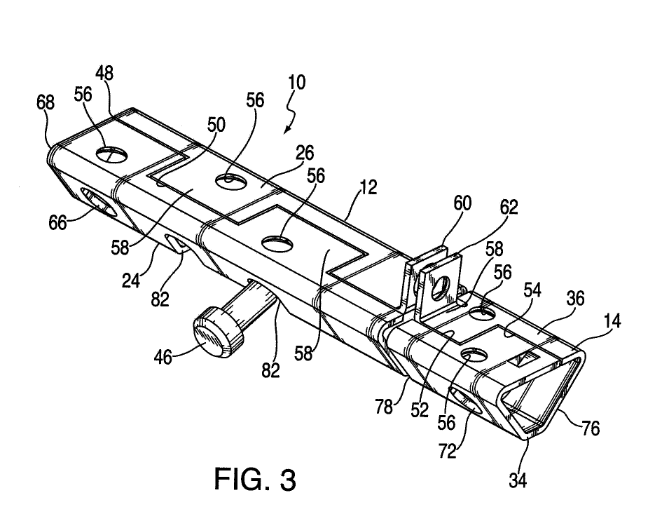

Referring now to FIG. 3, an important feature of the present security bolt 10 is that at least one of, and preferably both the case 12 and the strike 14 are configured so that opposed edges 48, 50 of the case and edges 52, 54 of the strike engage each other at the rear surfaces 26, 36 along a line obscured by the respective front surfaces 24, 34. Upon engagement of the edges, 48, 50 and 52, 54 the rear surfaces 26, 36 are planar.

It will be seen that the rear surfaces 26, 36 are each provided with at least one and preferably a plurality of fastener apertures 56. Further, it is contemplated that the edges 48, 50 and 52, 54 form a plurality of interengaging tabs 58 forming a notched, intermeshing relationship such that the line formed by the interengaging edges is not straight, but forms a block, zigzag shape. This arrangement is believed to increase the integrity of the case 12 and the 14 once they are mounted in place. Further, in the preferred embodiment, each tab 58 is provided with one of the fastener apertures 56. The apertures 56 are located in a staggered orientation. However, the arrangement and number of fastener apertures 56 may vary to suit the application.

Referring now to FIGS. 2-5, another feature of the present security lock 10 is that preferably each of the case 12 and the strike 14 is provided with a depending jam tab 60, 62 constructed and arranged for being fastened at a right angle to the rear surface 26 to a respective one of the edges 20, 22. Accordingly, each jam tab 60, 62 is provided with a mounting aperture 64. The presence of the jam tabs 60, 62 further enhances the security of the lock 10 by making it more difficult to remove.

Referring now to FIGS. 1 and 2, it is also preferred that the case 12 and preferably the strike 14 are provided respectively with a locked padlock aperture set 66 located adjacent an end 68 of the case 12 disposed on the front surface 24 in a position such that once the bolt 30 is in the extended position, a padlock shank 70 prevents retraction of the bolt. Similarly, a storage padlock aperture set 72 is located on the strike 14 on the front surface 34 such that when the bolt 30 is retracted, the padlock 74 is easily stored when not in use. More specifically, the storage padlock apertures set 72 is located adjacent an end 76 of the strike 14 free of engagement with the free end 40 of the bolt 30 in the retracted position.

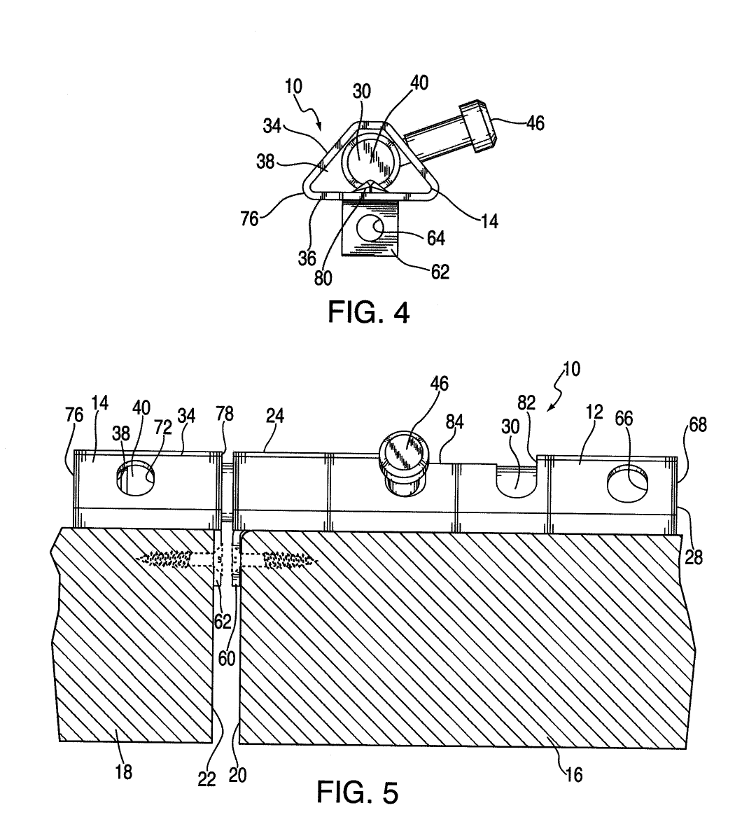

It will also be seen that the strike 14 has an end 78 open to receive the free bolt end 40, the end 78 being opposite the end 76, which is provided with a stop or blocking formation 80 (FIGS. 2, 4) obscuring the strike passageway 38 and further securing the bolt 30 in place.

To control the movement of the bolt 30 between the extended and retracted positions, the case 12 is provided on the front surface 24 with a pair of transversely projecting bolt slots 82 configured for receiving the bolt handle 46 in a selected one of the retracted and extended positions. Also, as is known in the art, the slots 82 are connected by an axially oriented slot 84, the combination forming a general “H”-shape when viewed from above or from the front. It will be seen that the front surface 24 of the case 12 is broken only by the padlock aperture set 66 which includes a pair of apertures, and the connected transverse bolt slots 82. Similarly, the front surface 34 of the strike 14 is broken only by the storage padlock aperture set 72, also including a pair of apertures.

Referring now to FIGS. 1, 2 and 4, it will be seen that the passageways 28, 38 are generally triangular in cross section, with the front surfaces 24, 34 forming a forwardly projecting wedge shape. This shape defines the passageways 28, 38 as well as facilitates the generally vertical alignment of the padlock aperture sets 66, 72. More specifically, the wedge shape of the front surfaces 24, 34 is truncated.

Thus, it will be seen that the present security bolt 10 addresses and overcomes the above-identified drawbacks of the prior art. The case 12 substantially hides the bolt 30, and has several features which make the bolt 10 more secure than conventional locks, especially when the bolt is located on the exterior of the enclosure being protected. These features include the hidden fastener apertures 56, the obscured and non-linear edges 48, 50, 52, 54 and the jam tabs 60, 62.

While a particular embodiment of the present security bolt has been shown and described, it will be appreciated by those skilled in the art that changes and modifications may be made thereto without departing from the invention in its broader aspects and as set forth in the following claims.

What is claimed:

1. A security bolt, comprising:
a unitary case including a front surface, a rear surface and formed to define a substantially enclosed, elongate passageway;
a strike having a front surface, a rear surface and formed to define a strike passageway being alignable with said elongate passageway;
an elongate bolt reciprocally engaged in said elongate passageway between a retracted position and an extended position in which a free end of said bolt is received in said strike passageway;
at least one of said case and said strike configured so that opposed edges engage each other at said rear surface along a line obscured by said respective front surface.

2. The security bolt of claim 1 wherein said rear surfaces are provided with fastener apertures configured for receiving securing fasteners.

3. The security bolt of claim 1 wherein said rear surfaces are provided with interengaging tabs forming a notched, intermeshing relationship.

4. The security bolt of claim 3, wherein each said tab is provided with a fastener aperture.

5. The security bolt of claim 1, wherein at least one of said case and said strike are provided with a depending jamb tab.

6. The security bolt of claim 1 wherein said case is provided with a locking padlock aperture disposed adjacent an end of said case.

7. The security bolt of claim 6 wherein said strike is provided with a storage padlock aperture adjacent an end of said case free of engagement with said free end of said bolt in said retracted position.

8. The security bolt of claim 1 wherein said strike has a first end forming an opening receiving said bolt, and an opposite second end provided with a blocking tab obscuring said strike passageway.

9. The security bolt of claim 1 wherein said case is provided with a pair of transversely projecting bolt slots configured for receiving a bolt handle in a selected one of said retracted and extended positions.

10. The security bolt of claim 9 wherein said bolt slots are connected by an axially oriented slot.

11. The security bolt of claim 1 wherein said passageways are generally triangular in cross section, with said front surfaces forming a forwardly projecting wedge shape.

12. The security bolt of claim 11 wherein said wedge shape is truncated.

13. The security bolt of claim 1 wherein said front surface of said case is broken only by a pair of padlock apertures, and a pair of connected transverse bolt slots.

14. The security bolt of claim 13 wherein said front surface of said strike is broken only by a pair of storage padlock apertures.

15. The security bolt of claim 1 wherein said bolt is a solid rod provided with a transverse handle fit into a transverse bore.

16. A security bolt, comprising:
a unitary case including a front surface, a rear surface and formed to define a substantially enclosed, elongate passageway;
a strike having a front surface, a rear surface and formed to define a strike passageway being alignable with said elongate passageway;
an elongate bolt reciprocally engaged in said elongate passageway between a retracted position and an extended position in which a free end of said bolt is received in said strike passageway;
both said case and said strike being configured so that opposed edges engage each other at said rear surface along a line obscured by said respective front surface;
said rear surfaces are provided with interengaging tabs forming a notched, intermeshing relationship along said opposed edges of said formed case.

17. The security bolt of claim 16 wherein each said tab is provided with a fastener aperture, said fastener apertures located in a staggered orientation.

18. A security bolt, comprising:
a unitary case including a front surface, a rear surface and formed to define a substantially enclosed, elongate passageway;
a strike having a front surface, a rear surface and formed to define a strike passageway being alignable with said elongate passageway;
an elongate bolt reciprocally engaged in said elongate passageway between a retracted position and an extended position in which a free end of said bolt is received in said strike passageway;
both said case and said strike being configured so that opposed edges engage each other at said rear surface along a line obscured by said respective front surface;
said front surface of said case is broken only by a pair of padlock apertures, and a pair of connected transverse bolt slots, said front surface of said strike is broken only by a pair of storage padlock apertures.
